(19) United States
(12) Patent Application Publication
(10) Pub. No.: US 2008/0053374 A1
(43) Pub. Date: Mar. 6, 2008

(54) ANIMAL FEEDING SYSTEMS AND ASSOCIATED METHODS

(75) Inventors: Nancy Kerrigan, Woburn, MA (US); Cory Williamson, Bozeman, MT (US)

Correspondence Address: PERKINS COIE LLP;PATENT-SEA, P.O. BOX 1247, SEATTLE, WA, 98111-1247, US

(73) Assignee: Evergreen Innovation Partners I, LP, Evergreen, CO (US)

(21) Appl. No.: 11/697,623

(22) Filed: Apr. 6, 2007

Related U.S. Application Data
(63) Continuation-in-part of application No. 11/514,511, filed on Aug. 31, 2006.

(51) Int. Cl. A01K 1/10

(52) U.S. Cl. 119/51.03

(57) ABSTRACT

A consumption-control feeding dish comprising a bowl structure having an interior wall that defines a concave interior area. The wall has an arcuate shape between an upper peripheral edge portion and a bottom surface. A protrusion is connected to the bottom surface of the interior wall and projects away from the bottom surface into the interior area. The protrusion has a central portion and a plurality of lobes positioned within the interior area and project radially from the central portion toward the interior wall. The lobes, in combination with the interior wall and the protrusion, define a plurality of curvilinear feeding zones shaped to retain food for the animal and sized to prevent the animal from opening its mouth to open position and taking a full bite of the food, thereby requiring the animal to take a plurality of small bites of food to consume the same amount of food in a full bite.

### CROSS-REFERENCE TO RELATED APPLICATIONS

This application is a continuation-in-part of U.S. patent application Ser. No. 11/514,511 filed Aug. 31, 2006, which is incorporated herein by reference in its entirety.

### TECHNICAL FIELD

The present invention is related to animal feeding systems and associated methods including dog food bowls.

### BACKGROUND

It is estimated that roughly 35% of dogs consume their food too quickly. This can lead to physical problems for the dog, including gagging, flatulence, burping, choking, regurgitation, and in extreme cases, death. In addition to the physical effect on the dog, there can be psychological effects on the dog's owner. For example, dog owners are typically very concerned for the dog's health when they see or hear the dog eating too quickly, and the owners may even panic in an effort to help the dog. Additionally, dog owners are often financially impacted if and when help is sought from a veterinarian or other animal husbandry professional to treat a dog that has experienced physical problems from eating too quickly or when they have to deal with the death of a pet.

### SUMMARY

The present invention is directed generally toward animal feeding systems and associated methods including dog food bowls. One aspect of the invention is directed toward a feeding dish for use in feeding an animal having a mouth that can move between a closed position and an open position sufficient to take a full bite of food. The feeding dish comprises a bowl structure having an interior wall that defines a concave interior area. The wall has an arcuate shape between an upper peripheral edge portion and a bottom surface. A protrusion is connected to the bottom surface of the interior wall and projects away from the bottom surface into the interior area. A plurality of dividers are positioned within the interior area and project radially relative to the interior wall toward the protrusion. The dividers in combination with the interior wall and the protrusion define a plurality of curvilinear feeding zones shaped to retain food for the animal and sized to prevent the animal from opening its mouth to an open position and taking a full bite of the food, thereby requiring the animal to take a plurality of small bites of food to consume the same amount of food as in a full bite.

In another embodiment, a feeding dish comprises a bowl having a curvilinear interior surface that defines a concave interior area, a protrusion connected to the bowl and projecting into the interior area, and a plurality of dividers positioned within the interior area. The dividers project radially inwardly relative to the bowl toward the protrusion. The dividers in combination with the bowl and the protrusion define a plurality of curvilinear feeding zones in the interior area configured to contain food therein. The feeding zones are sized to prevent the dog from opening its mouth to an open position sufficient to take a full bite of food from a feeding zone, thereby requiring the dog to take a plurality of small bites of food.

In another embodiment, an animal-feeding dish is provided that comprises a bowl structure having an interior curvilinear wall portion that defines an interior area. The wall portion has an arcuate shape, a peripheral edge portion, and a bottom surface spaced vertically apart from the peripheral edge portion. A central protrusion is located within the interior area of the bowl structure. The central protrusion is connected to the curvilinear wall portion adjacent to the bottom surface and projects away from the bottom surface. A plurality of dividers are located within the interior area vertically intermediate the bottom surface and the peripheral edge portion. The dividers project radially relative to the wall portion toward the central protrusion. The dividers in combination with the wall portion and the central protrusion define a plurality of feeding zones shaped to retain food for the animal and shaped to limit how far the animal can open its mouth when taking a bite of the food, thereby preventing the animal from taking a full bite of food from a feeding zone.

In a further embodiment, a consumption-control feeding dish is provided having a bowl structure with an interior wall defining an interior area. The interior wall has an arcuate shape between an upper peripheral edge portion and a bottom surface. The feeding dish further includes a protrusion which is connected to the bottom surface of the interior wall and which projects away from the bottom surface into the interior area. The protrusion has a central portion and a plurality of integrally connected lobes projecting radially from the central portion and toward the interior wall. The protrusion in combination with the interior wall define a plurality of curvilinear feeding zones shaped to retain animal food for an animal. The feeding zones are beneficially sized to limit the extent the animal can open its mouth when in one of the feeding zones to intake food, thereby requiring the animal to take a plurality of small bites of food.

### BRIEF DESCRIPTION OF THE DRAWINGS

FIG. 1 is an isometric illustration of a consumption-control feeding dish for use by a dog or other animal in accordance with an embodiment of the invention.

FIG. 2 is an isometric illustration of an animal proximate to the feeding dish shown in FIG. 1.

FIG. 3 is an isometric illustration of multiple animals having varying physical characteristics.

FIG. 4 is an isometric illustration of a stackable feeding dish in accordance with another embodiment of the invention.

FIG. 5 is an isometric cross-sectional view of a plurality of the feeding dishes of FIG. 4 shown in a nested and stacked configuration.

FIG. 6 is an isometric illustration of a feeding dish in accordance with another embodiment of the invention.

FIG. 7 is an isometric illustration of a feeding dish in accordance with another embodiment of the invention.

FIG. 8 is a partially exploded isometric illustration of the feeding dish of FIG. 7.

FIG. 9 is an isometric illustration of a feeding dish in accordance with another embodiment of the invention.

FIG. 10 is an isometric illustration of a feeding dish in accordance with another embodiment of the invention.

FIG. 11 is a top plan view of a feeding dish in accordance with another embodiment of the invention.

FIG. 12 is an isometric illustration of a feeding dish in accordance with another embodiment of the invention.

FIG. 13 is an isometric illustration of a feeding dish in accordance with another embodiment of the invention.

FIG. 14 is an isometric illustration of a feeding dish in accordance with another embodiment of the invention.

FIG. 15 is an isometric illustration of a feeding dish in accordance with an embodiment of the invention showing our design.

FIG. 16 is a front elevation view of the feeding dish shown in FIG. 15. The left-side, right-side, and back elevation views of this embodiment are substantially the same as the front elevation view.

FIG. 17 is a top view of the feeding dish shown in FIG. 15.

FIG. 18 is a bottom view of an embodiment of the feeding dish illustrated in FIG. 15.

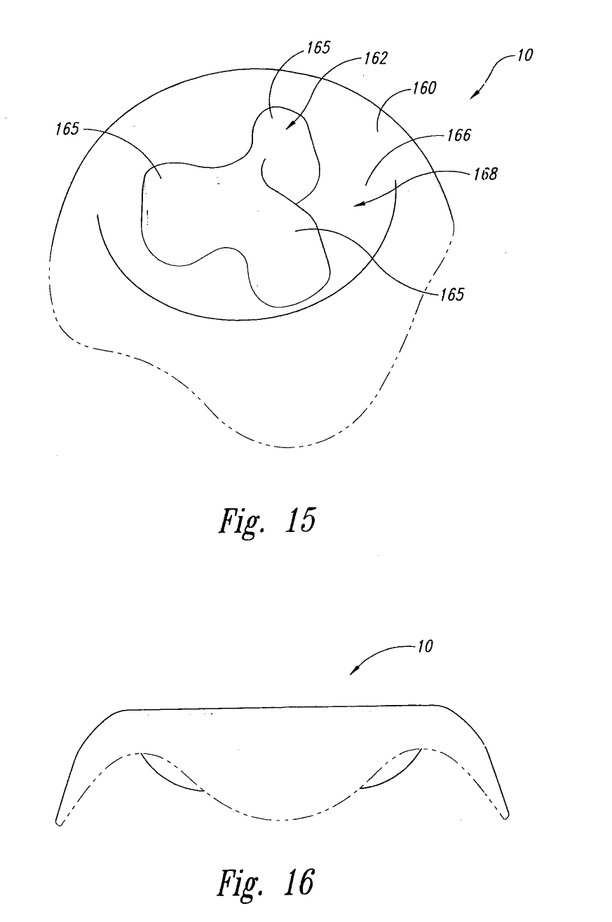

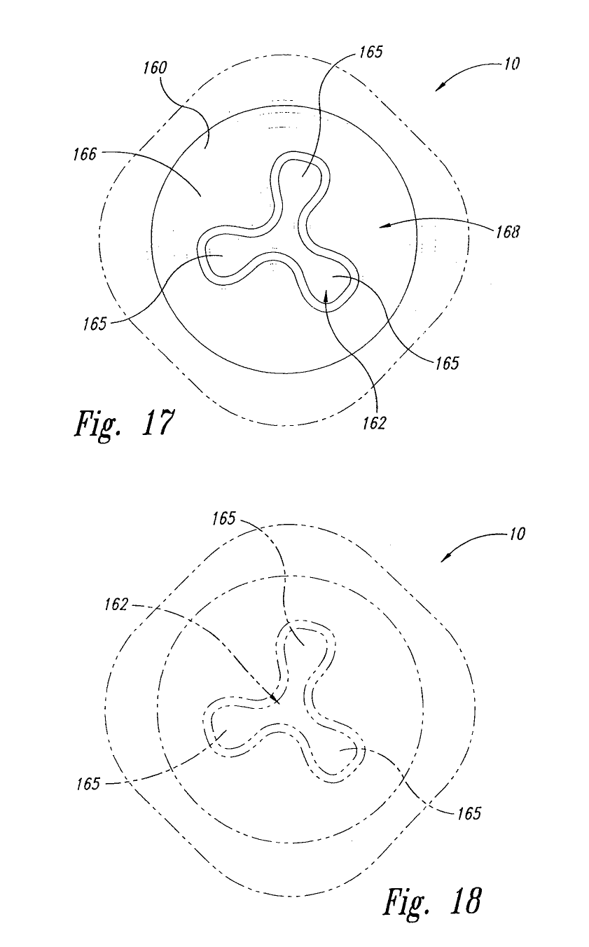

Appendix A contains information regarding an ornamental design of the feeding dish of FIGS. 15-18.

### DETAILED DESCRIPTION

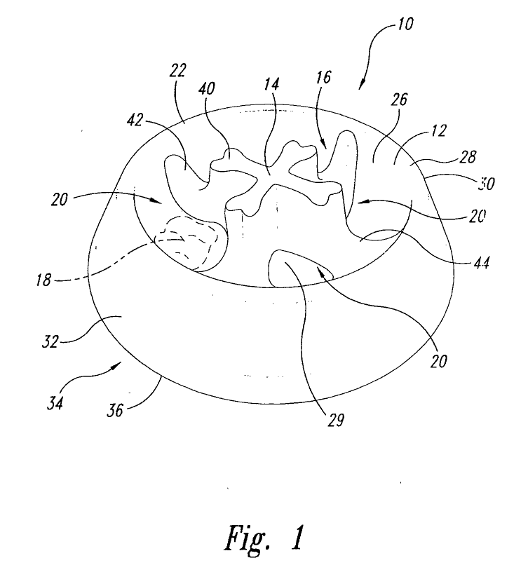

The present disclosure describes animal feeding systems and associated methods including dog food bowls. Several specific details of the invention are set forth in the following description and in FIGS. 1-18 to provide a thorough understanding of certain embodiments of the invention. One skilled in the art, however, will understand that the present invention may have additional embodiments, and that other embodiments of the invention may be practiced without several of the specific features described below.

FIG. 1 is an isometric illustration of a consumption-control feeding dish 10 for use by a dog or other animal in accordance with an embodiment of the invention. The feeding dish 10 is described and shown herein, for purposes of illustration, as a feeding dish for a dog, but it will be understood by one of ordinary skill in the art that the consumption-control feeding dish can be used for other animals. The feeding dish includes a bowl structure 12 configured with a protrusion 14 within an interior area 16 of the bowl structure. The bowl structure and protrusion are configured to limit a dog's access to food carried by the feeding dish. Embodiments of the feeding dish are also configured so the dog must move and reposition its body and head relative to the bowl structure multiple times to get to all of the food in the bowl structure. Accordingly, the feeding dish is configured to at least partially control the dog's eating action and to prevent the dog from eating at an excessive rate of consumption.

As used herein, an eating action includes an increment in the incremental process of a dog (or other animal) transferring food from a feeding system to the dog's mouth. The increments are referred to herein as including when a dog takes a bite of food. A bite of food includes when the dog transfers food from a feeding system to its mouth by grasping portions of the food via jaw articulation, with or without associated tongue articulation to manipulate the food into the dog's mouth.

In selected embodiments the dog's access to food 18 (shown in phantom lines) can be limited by the bowl structure 12 and the protrusion 14 to provide a plurality of smaller feeding zones 20 sized to limit the dog's range of jaw articulation, thereby preventing the dog from taking a full unrestricted bite food when the dog's snout is in the feeding zone. As a result, the dog must take smaller bites of food, thereby limiting the amount of food the dog can get per bite.

The feeding dish 10 with the feeding zones 20 is configured so that the dog must reposition its head or body to move from one feeding zone to access the next feeding zone. This repositioning by the dog also slows down the dog's rate of consumption during the eating process. By reducing the dog's rate of consumption, the problems associated with a dog eating too quickly can substantially be avoided.

Referring again to FIG. 1, the feeding dish 10 of the illustrated embodiment includes a bowl structure 22 having an interior wall 26 that defines a concave interior area 16. The bowl structure of the illustrated embodiment has a generally circular shape, although other embodiments can have a bowl structure with other geometric or non-geometric shapes. The interior wall has an arcuate shape in at least two orthogonal directions between an upper lip 28 and a bottom portion 29 of the bowl structure that defines the bottom of the interior area. The upper lip defines an upper peripheral edge portion 30 around the bowl structure at the top of the interior area. The bowl structure has a base portion 32 that engages a support surface 34, such as a floor, the ground, or other structure on which the feeding dish is placed.

The base portion 32 can include one or more anti-skid materials 36 configured to resist sliding movement of the feeding dish 10 over the support surface 34. In one embodiment, the anti-skid material is a soft elastomeric ring attached to the bottom edge of the base portion. The elastomeric ring has a high coefficient of friction, so it resists sliding along the support surface when the dog is eating. The anti-skid material, including an elastomeric material or other suitable material with a relatively high coefficient of friction, can be a separate component of the base portion or it can be an integral component of the base portion.

The feeding dish 10 includes the protrusion 14 connected to the interior wall 26 and projects upwardly from the bottom surface into the interior area 16. In the illustrated embodiment, the protrusion is integrally connected to the interior wall and is generally centrally disposed within the interior area. In other embodiments, the protrusion can be a separate device fastened, adhered, or otherwise connected to the interior wall, and/or the protrusion can be positioned off-center within the interior area.

In the illustrated embodiment, the protrusion 14 includes a plurality of lobes 40 that project radially outward within the interior area. The feeding dish 10 also includes a plurality of dividers 42 positioned within the interior area 16 and projecting radially between the interior wall 26 and the protrusion. The dividers of the illustrated embodiment are radially aligned with the lobes of the protrusion.

The dividers 42 in the illustrated embodiment terminate along a top edge 44 located vertically lower than the upper lip 28 of the bowl structure 12. The dividers can have different heights relative to the bottom surface in other embodiments. The multiple dividers within the interior area can have the same height relative to each other within the bowl structure, or different dividers can have different heights relative to each other. The dividers in the illustrated embodiment are integrally connected to the interior wall 26 and to the protrusion 14 so as to form smoothly contoured feeding zones 20 that have no sharp corners or crevices into which the food could get trapped. Accordingly, the dog can effectively extract the food from the feeding zones, albeit in smaller bites and over a longer time period. This configuration also provides a feeding dish that can easily be cleaned, rinsed, or wiped out by the dog's owner.

The dividers in combination with the interior wall and the protrusion define a plurality of the curvilinear feeding zones 20 shaped to retain a portion of the dog's food 18. The feeding zones are configured to have a substantially continuously increasing cross-sectional area moving upwardly toward the upper lip 28. The feeding zones are separated concave areas, so that the food 18 from one feeding zone will not re-aggregate at the bottom of the bowl structure with food from the other feeding zones. Each of the feeding zones are also sized relative to the dog's snout and mouth so as to prevent the dog from being able to fully open its mouth and take a full bite of the food. Accordingly, the dog is required to take a plurality of small bites of food to consume the same amount of food that the dog could gather in a full bite.

The feeding dish 10 of the illustrated embodiment is made of a strong, durable, injection molded plastic material. The feeding dish's bowl structure 12, dividers 42, and the smooth feeding zones 20 are configured so the feeding dish can be manufactured by injecting a flowable material into a mold. After the material has solidified (e.g., cured), the feeding dish is easily removed from the mold. In another embodiment, the feeding dish can be formed of a metal or other suitable material conformable using a stamping process. Accordingly, feeding dishes can be made quickly, in high volumes and in a low cost manner.

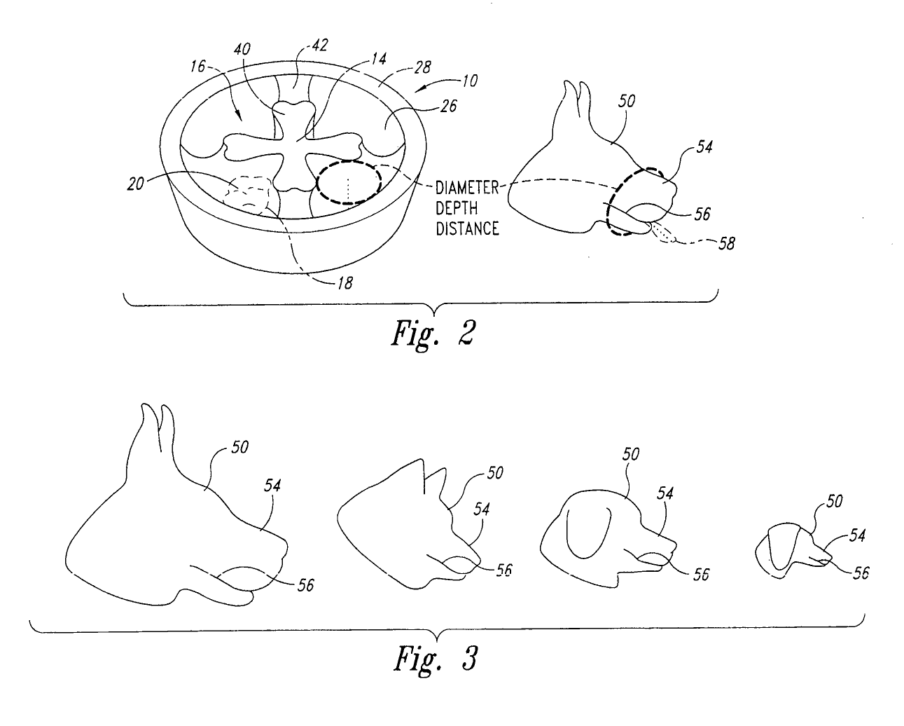

FIG. 2 is an isometric illustration of a dog 50 proximate to the feeding dish 10 shown in FIG. 1. The dog has determinable physical characteristics, which can be selected and used to determine the configuration of the feeding system. For example, in the illustrated embodiment, the dog has a muzzle 54, a mouth 56, and a tongue 58. The muzzle has a certain size and shape, including a circumference (e.g., measured at a selected location) and a length that is related to the range of the dog's jaw articulation. The dog's mouth and tongue can also have measurable sizes that directly effect the dog's eating action and the amount of food that the dog could gather during a full, unrestricted bite.

As seen in FIG. 3, the general size of the physical characteristics of different dogs can significantly vary depending upon multiple factors, including the breed and/or age of the dog. For example, the physical characteristics of a Great Dane, particularly the muzzle 54, mouth 56, tongue 58, and jaw articulation, are significantly larger than the physical characteristics of a Pomeranian, Chihuahua, or other small dog. Accordingly, the feeding dish 10 (FIG. 2) can be provided in different sizes, thereby providing feeding zones 20 of different sizes for dogs of different sizes to limit the dog's jaw articulation while its muzzle is in the particular feeding zone. This limits the amount of food 18 that the dog 50 can transfer into its mouth in each bite, thereby limiting how fast the dog can eat all of the food in the bowl structure 12.

The feeding dish 10 with the protrusion 14 and the feeding zones 20 are also configured so that the dog is motivated and/or required to make continuous adjustments with its mouth, head, and/or body to be able to get to the food in all of the feeding zones. Because the dog must make these adjustments with its mouth, head, and/or body, the dog's consumption rate can be reduced. When the dog is moving around the feeding dish and burying its muzzle into the feeding zones, the anti-skid feature helps keep the feeding dish from sliding too much. In another embodiment, the feeding dish can be configured so it will easily slide over the support surface, so the dog will have to effectively chase the dish around as the dog eats and the dish slides.

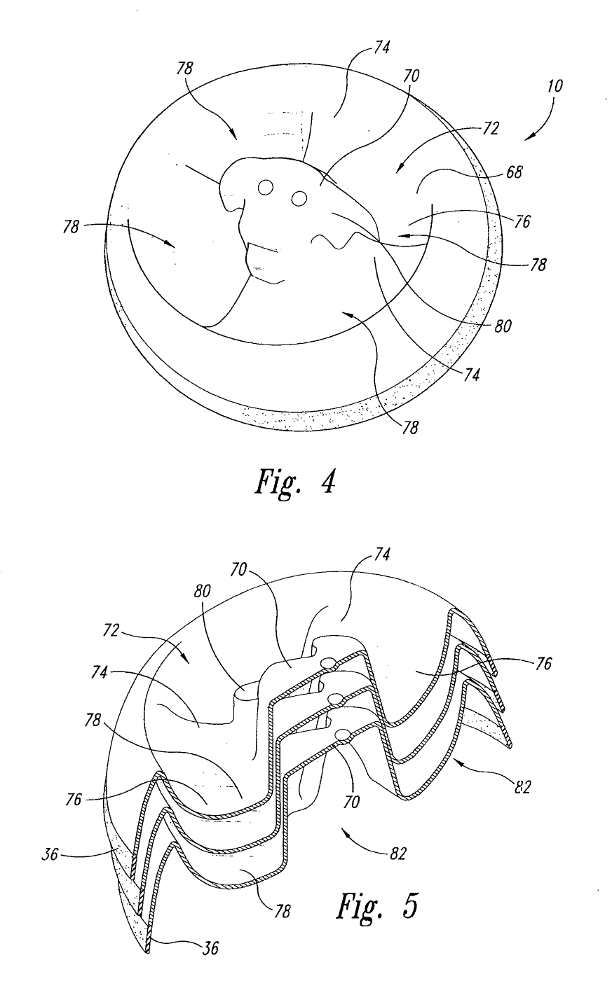

FIG. 4 is an isometric illustration of a stackable feeding dish 10 in accordance with another embodiment of the invention. The feeding dish has a bowl structure 68 with a protrusion 70 projecting upwardly into an interior area 72, and a plurality of dividers 74 extending radially from a curvilinear interior wall 76 to the protrusion to define a plurality of feeding zones 78. The protrusion in the illustrated embodiment has a contoured shape that looks like a dog's head. This dog-shaped protrusion has a plurality of lobes 80 radially aligned with the dividers to help define and separate the feeding zones. While the protrusion of the illustrated embodiment has a dog-head shape, the protrusion in other embodiments can have other shapes, including geometric or non-geometric shapes.

The feeding dish 10 of the illustrated embodiment is an injection molded, unitary structure made of a durable plastic or other suitable material. In another embodiment, a single-piece unit can be stamped or otherwise formed out of metal, such as stamped stainless steel, aluminum, or other stampable material. The feeding dish has a substantially hollow underside 82 shaped and sized to nest with other feeding dishes of the same construction, as seen in FIG. 5. Accordingly, multiple feeding dishes can stack upon each other, which allows for efficient use of space for shipping, storage, and/or shelving. This single-piece, stackable construction also allows for simplified tooling, efficient manufacturing, and low manufacturing costs.

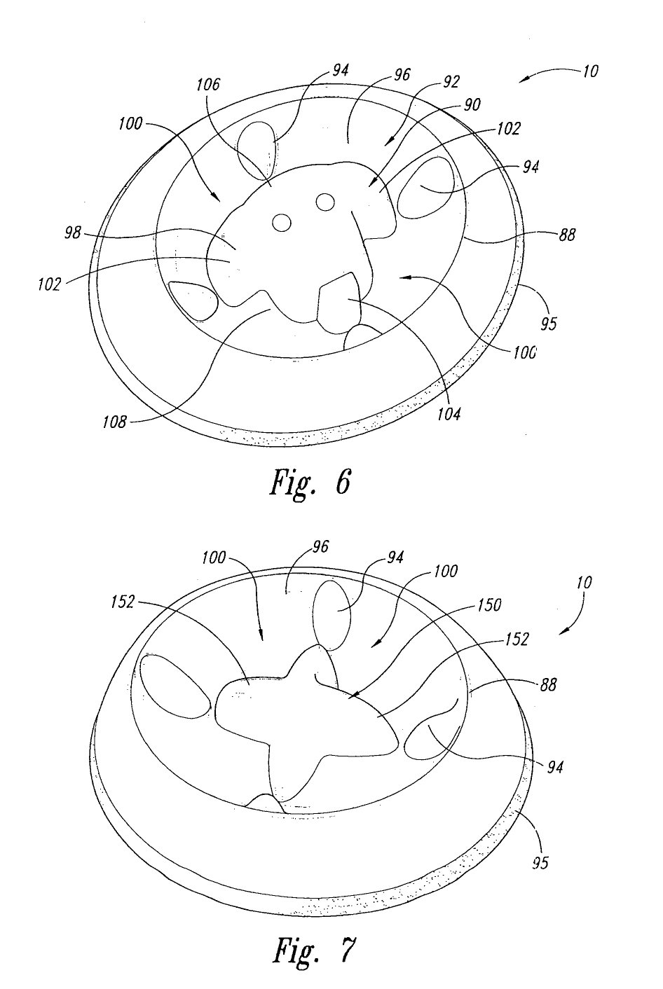

FIG. 6 is an isometric illustration of a feeding dish 10 in accordance with another embodiment of the invention. The feeding dish has a generally oval-shaped bowl structure 88 with a protrusion 90 projecting upwardly into an interior area 92, and a plurality of dividers 94 extending radially inwardly from a curvilinear interior wall 96 toward the protrusion. The bowl structure 88 of the illustrated embodiment is a smooth, durable stainless steel bowl or other metallic unit. While the illustrated bowl structure is stainless steel and generally oval-shaped, the bowl structure can be made of other durable materials and can have other shapes, geometric or non-geometric. The illustrated feeding dish also includes an anti-skid portion 95 thereon, substantially as discussed above, although other embodiments do not include the anti-skid portion.

The protrusion is illustrated as a multi-lobed member with each lobe 98 generally radially aligned with a respective one of the dividers. Accordingly, the lobes of the protrusion in combination with the interior wall and the dividers define a plurality of feeding zones 100. The feeding zones are configured to limit the dog's range of jaw articulation, thereby preventing the dog from taking a full unrestricted bite of food when the dog's snout is in the feeding zone, as discussed above.

In the illustrated embodiment, the dividers 94 are integrally formed in the interior wall 96 and project radially into the interior area 92 toward the protrusion 90. This configuration provides a simple, clean structure that can be easily manufactured by stamping from a metal blank, injection molding, or other forming process. The dividers are illustrated as terminating adjacent to the protrusion without directly engaging the protrusion. The dividers in other embodiments can engage the protrusion, and in other embodiments the dividers can be integrally connected to the protrusion.

The protrusion 90 in the illustrated embodiment has a contoured shape that looks like a dog's head having radially extending lobes 98 in the shape of ears 102, a tongue 104, and a crown 106 of the head. The protrusion with its lobes can have other shapes in other embodiments. The illustrated protrusion is securely attached to the bottom surface 108 of the interior wall, so that the protrusion will not move within the interior area when the dog is eating from the feeding zones. The protrusion can be removably connected to the bottom surface of the interior wall, thereby providing for easy cleaning of the bowl. The removable protrusion also enables the feeding dish to be a convertible dish that can be used with the protrusion in place or removed from the bowl structure. For example, the protrusion can be securely inserted into the bowl structure when a dog's consumption rate needs to be controlled, and the protrusion can be removed so the bowl can be used when the dog's consumption rate does not need to be controlled.

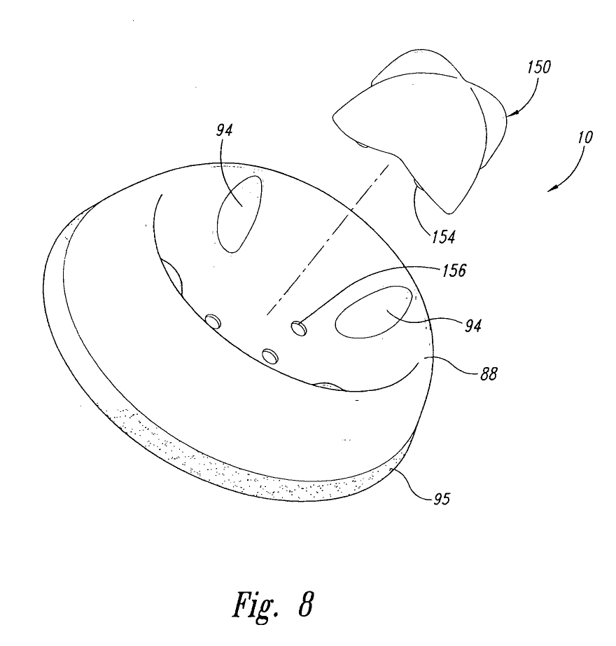

FIG. 7 is an isometric view of a feeding dish 10 in accordance with another embodiment of the invention, and FIG. 8 is a partially exploded isometric illustration of the feeding dish of FIG. 7. The illustrated feeding dish has a bowl structure 88 with the integral dividers 94 substantially the same as the embodiment described above in connection with FIG. 6. The illustrated feed dish also has a central protrusion 150 removably connected to the interior wall 96. The central protrusion has a plurality of leg portions 152 arranged to form a “+” shape, with each leg portion being radially aligned with the dividers. Accordingly, the central protrusion, the dividers, and interior wall define the feeding zones.

The feeding dish 10 of the illustrated embodiment is a two-piece dish assembly that allows a user to change the size of the feeding zones 100 by changing the central protrusion. For example, a dog owner can insert a central protrusion 150 having leg portions 152 into the bowl structure so as to form the feeding zones 100 with a selected shape and size. If the owner wants to provide larger feeding zones for the dog, the owner can remove the central protrusion and replace it with another protrusion having, as an example, skinnier and/or shorter leg portions. Alternatively, the owner can create smaller feeding zones by installing a larger central protrusion into the bowl structure, such as a central protrusion having longer and/or thicker leg portions. This removable central protrusion provides the owner with a significant degree of flexibility in providing a feeding dish that meets the needs of the dog (or other animal). Additional flexibility for the owner can be achieved in another embodiment wherein the dividers are removable and replaceable with dividers of different sizes.

The central protrusion 150 in the illustrated embodiment has a plurality of pegs 154 (FIG. 8) that press into alignment holes 156 formed in the bottom surface of the bowl structure 88. The alignment holes in the illustrated embodiment are sealed, blind holes such that the feeding dish 10 can also be used as a dish for water or other fluids. In other embodiments, the alignment holes can be through-holes that allow for drainage from the interior area, such as when the feeding dish is being cleaned. The pegs securely hold the central protrusion in alignment with the dividers by frictional engagement with the bowl structure. In other embodiments, the central protrusion can be securely locked or otherwise held in place by other securing mechanisms or methods.

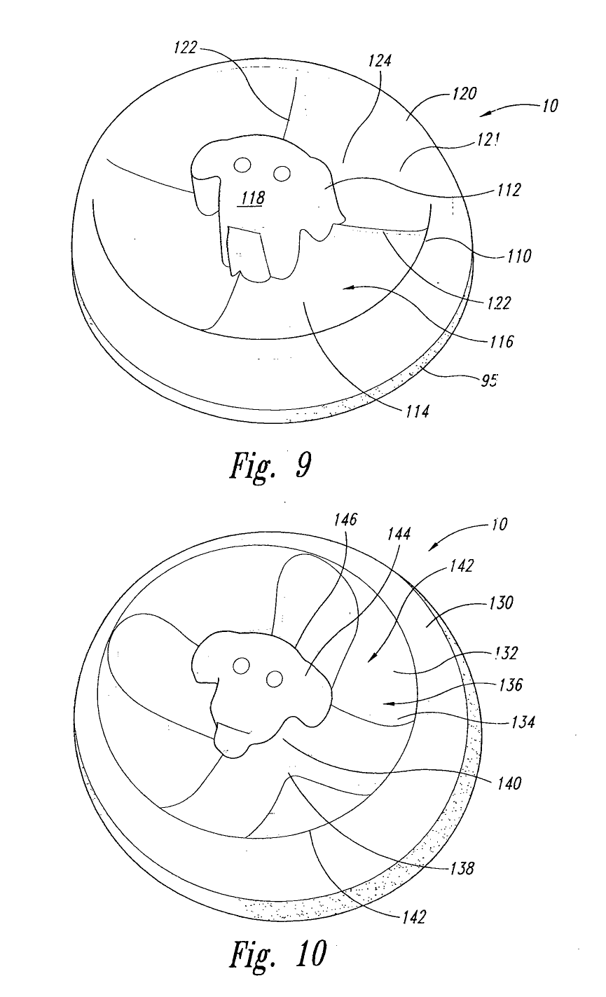

FIG. 9 is an isometric illustration of a feeding dish 10 in accordance with another embodiment of the invention. The feeding dish has a generally circular bowl structure 110 with a multi-lobed protrusion 112 in the shape of a dog's head, similar to the protrusion discussed above. The protrusion is integrally connected to a bottom surface 114 of the bowl structure and projects upwardly into an interior area 116. A top surface 118 of the protrusion in the illustrated embodiment is substantially coplanar with an upper lip 120 of the bowl structure. In other embodiments, the top surface of the protrusion can be below the upper lip and within the interior area. In yet other embodiments, the protrusion can extend upwardly past the upper lip and out of the bowl structure.

The bowl structure 110 has a curvilinear interior wall 121 and a plurality of integral dividers 122 extending radially inwardly toward the protrusion 112. The dividers are also integrally connected to the lobes of the protrusion to define feeding zones 124. The dividers in the illustrated embodiment are shaped to form acutely angled edge portions between adjacent feeding zones. The dividers in other embodiments can have different shapes, such as a more rounded shape forming smooth transitions between adjacent feeding zones. The illustrated feeding dish also includes an anti-skid portion 95 thereon, substantially as discussed above, although other embodiments do not include the anti-skid portion.

FIG. 10 is an isometric illustration of a feeding dish 10 in accordance with yet another embodiment of the invention. The feeding dish has a generally circular bowl structure 130 with an interior wall 132 and a plurality of dividers 134 integrally connected to the interior wall and extending across an interior area 136. The dividers of the illustrated embodiment meet at a central portion 138 of the bowl structure to form a central protrusion 140 within the interior area. Accordingly, the dividers, the central protrusion, and the interior wall define the feeding zones 142, which are shaped and sized to limit how far the dog can open its mouth when its muzzle is in a feeding zone.

The feeding dish of the illustrated embodiment also includes a restrictor 144 attached to the top of the central protrusion. The restrictor in the illustrated embodiment is shaped and sized so its peripheral area forms an overhang portion 146 that extends over part of the feeding zones 142. Accordingly, the restrictor decreases the size of the opening into each feeding zone, thereby creating a partial barrier that limits how much the dog can move its muzzle within the feeding zone while eating. The restrictor can also be configured to limit how far the dog can open its mouth while trying to get a bite of food.

In the illustrated embodiment, the restrictor 144 is in the shape of a dog's head, although other shapes could be used. The illustrated restrictor is also removably connected to the central protrusion 140, thereby providing a two-piece feeding dish 10. In one embodiment, the restrictor has one or more pins that press fit into receiving holes in the central protrusion, so that the restrictor is held in place via a friction fit. In another embodiment, the central protrusion can have integral pins that securely fit into holes in the restrictor. In other embodiments, the restrictor can be connected to the central protrusion with conventional fastener or other conventional securing means.

In one embodiment, the restrictor 144 can be configured to rotate relative to the central protrusion 140, and it can be asymmetric so as to allow access to one feeding zone 142 while at least partially blocking access to other feeding zones 142 until the dog rotates the restrictor, e.g., by moving the restrictor with its muzzle. The replaceable restrictor also allows the same bowl structure 110 to be used with a plurality of restrictors of different sizes. For example, if one dog's consumption rate needs to be slowed down significantly, a larger restrictor can be attached to the central protrusion, thereby decreasing the access area into the feeding zones. If another dog needs only a minor adjustment in its consumption speed, then a smaller restrictor could be used.

In yet another embodiment, different restrictors having different shapes, or colors, or other identifiers could be used on a common bowl structure, such as to differentiate the feeding dishes for different dogs. In yet another embodiment, the restrictor could be customized, such as colored, monogrammed, engraved, or otherwise adorned with a dog's name or other symbol, indicia, or design.

In another embodiment, the feeding dish 10 can include an overhang portion extending radially inwardly from the upper lip around the peripheral portion of the bowl structure. The overhang portion is configured to extend over part of the feeding zones, thereby decreasing the area through which the dog can access the feeding zones. This overhang portion can be an integral portion of the upper lip. In another embodiment, the overhang portion can be a separate component attached to the upper lip. In one embodiment, the overhang portion can be removably connected to the upper lip portion.

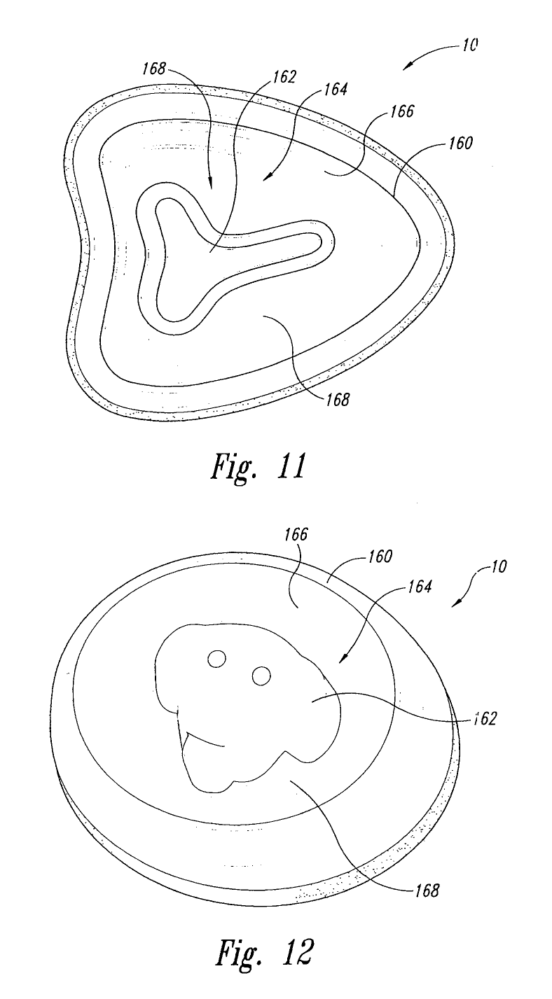

FIGS. 11-14 are isometric views of feeding dishes 10 in accordance with another embodiment of the invention. The feeding dishes have a shaped bowl structure 160 with a contoured protrusion 162 projecting upwardly into the interior area 164. Each contoured protrusion is positioned relative to a curvilinear interior wall 166 so as to define a plurality of smaller feeding zones 168 shaped and sized to limit the dog's range of jaw articulation substantially as discussed above, thereby preventing the dog from taking a full unrestricted bite of food when the dog's snout is in the feeding zone. As a result, the dog must take smaller bites of food, thereby limiting the amount of food the dog can get per bite.

The bowl structure 160 and contoured protrusion 162 can have a wide variety of shapes and sizes while still providing the properly sized feeding zone along the curvilinear interior wall. For example, FIG. 11 shows an embodiment of the feeding dish 10 wherein the bowl structure and contoured protrusion are shaped, sized, and colored to generally appear like a T-bone steak. FIG. 12 shows an embodiment of the feeding dish 10 wherein the bowl structure and a contoured protrusion are configured to provide a “dog dish” because the protrusion has the appearance of a dog's head.

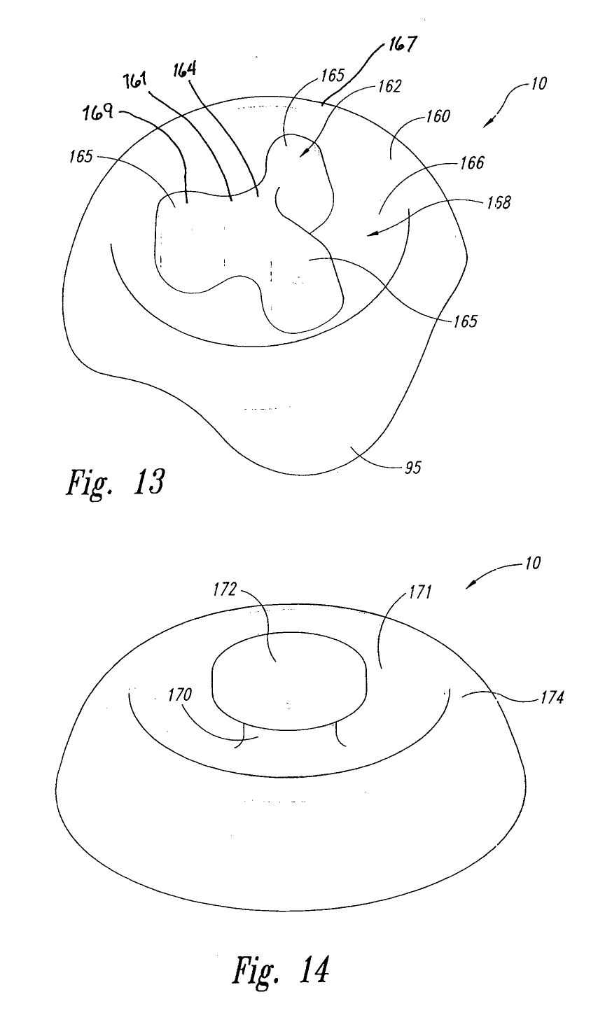

FIG. 13 shows an embodiment wherein the feeding dish 10 with the bowl structure 160 and a multi-lobed contoured protrusion 162 with a plurality of integrally connected lobes 165 is positioned adjacent to the curvilinear interior wall 166 to define the feeding zones 168.

FIG. 13 illustrates an embodiment of the feeding dish 10, and FIGS. 15-18 illustrate an ornamental design of the feeding dish. As seen in FIG. 13, the feeding dish 10 has a shaped bowl structure 160 with a curvilinear interior wall 166 and a contoured protrusion 162 centrally disposed in the bowl structure. The protrusion 162 has a plurality of integrally connected lobes 165 disposed relative to the interior wall to define feeding zones 168. In one embodiment, the protrusion 162 has three integrally connected lobes 165 extending radially from a central portion 164 of the protrusion. The protrusion is shown as being centrally disposed within the bowl structure, although the protrusion can be positioned off-center.

In one embodiment, the lobes 165 are substantially equally spaced radially apart from each other. The space formed between the lobes 165 and the curvilinear interior wall 166 defines the smaller feeding zones 168. The feeding zones 168 are illustrated as being substantially the same size. In another embodiment, the lobes 165 can be sized and/or radially distributed to provide feeding zones 168 of different sizes within the bowl structure. In yet another embodiment, the protrusion 162 can have more than three lobes 165 that define more than three feeding zones 168.

In the illustrated embodiment, the lobes 165 each have a narrow proximal portion 161 adjacent to the central portion 164, and a wider distal portion 169 is spaced apart from the central portion. The illustrated distal portion 169 has a bulbous shape that helps define the shape of the feeding zones 168. In other embodiments, the lobes 165 can have other shapes.

In one embodiment, the contoured protrusion 162 has a height that does not exceed the height of the interior wall 163 and peripheral edge 167 of the bowl structure 160. In another embodiment, the protrusion 162 can have a height that is substantially equal to the height of the interior wall 163. In a further embodiment, the protrusion 162 can have a height greater than the height of the interior wall 163. In yet another embodiment, not shown, the height of the plurality of integrally connected lobes 165 exceeds the height of the protrusion 162. One of ordinary skill in the art will appreciate that the height of the protrusion 162 and the height of the lobes 165 may vary independently and with respect to the height of bowl structure 160.

FIG. 14 shows an embodiment of the feeding dish 10 with the bowl structure and an elongated, oval-shaped protrusion positioned adjacent to the curvilinear interior wall 166 to define a substantially annular feeding zone 168 with a limited area into which the dog or other animal can position its muzzle. The feeding dish 10 of the illustrated embodiment has a projection 170 in the interior area and a restrictor 172 on the top portion of the projection. The restrictor can be removably connected to the projection as discussed above. In another embodiment, the restrictor can be integrally formed with the projection. The projection can be integrally connected to the bowl structure 174, and in another embodiment, the projection can be removably connected to the bowl structure, as discussed above.

The feeding dish of another embodiment has an outer lip attached to the upper peripheral edge of the bowl structure. The outer lip extends radially inward toward the protrusion and over a portion of the feeding zone. The lip can be integrally connected to the bowl structure, permanently affixed to the bowl structure, or removably attached to the bowl structure. Accordingly, the lip acts as an outer restrictor that can limit the dog's access into the feeding zone. The lip also acts as a barrier to help keep food, water, or other contents from spilling out of the bowl structure. This embodiment can also be provided with a projection integrally or removably attached to the bowl structure. A restrictor can also be connected to the projection as discussed above. Other shapes and configurations can be provided in other embodiments.

From the foregoing, it will be appreciated that specific embodiments of the invention have been described herein for purposes of illustration, but that various modifications may be made without deviating from the invention. Additionally, aspects of the invention described in the context of particular embodiments may be combined or eliminated in other embodiments. Furthermore, while advantages associated with certain embodiments of the invention have been described in the context of those embodiments, other embodiments may also exhibit such advantages, and not all embodiments need necessarily exhibit such advantages to fall within the scope of the invention. Accordingly, the invention is not limited except as by the appended claims.

I claim:

1. A consumption-control feeding dish, comprising:
a bowl structure having an interior wall that defines a concave interior area, the wall having an arcuate shape between an upper peripheral edge portion and a bottom surface; and
a protrusion connected to the bottom surface of the interior wall and projecting away from the bottom surface into the interior area, the protrusion having a central portion and a plurality of lobes projecting radially from the central portion and toward the interior wall, the protrusion in combination with the interior wall define a plurality of curvilinear feeding zones shaped to retain animal food for an animal and sized to limit the extent the animal can open its mouth when in one of the feeding zones to intake food, thereby requiring the animal to take a plurality of small bites of food to consume the same amount of food in a full bite.

2. The feeding dish of claim 1 wherein the protrusion is integrally connected to the interior wall.

3. The feeding dish of claim 1 wherein the bowl structure and the protrusion are integrally connected in a unitary, injection molded construction.

4. The feeding dish of claim 1 wherein the protrusion is removably coupled to the bowl structure.

5. The feeding dish of claim 1 wherein the protrusion has at least three lobes integrally connected to each other.

6. The feeding dish of claim 1 wherein the protrusion includes at least three radially extending lobes, wherein the lobes are substantially uniformly spaced apart from each other.

7. The feeding dish of claim 1 wherein the lobes project from the bottom surface into the interior area and terminate at a height less than the upper peripheral edge.

8. The feeding dish of claim 1 wherein at least one of the protrusion and the plurality of integrally connected lobes project from the bottom surface into the interior area at a height substantially equal to the upper peripheral edge.

9. The feeding dish of claim 1 wherein the lobes include a bulbous distal portion spaced apart from the central portion.

10. The feeding dish of claim 1 wherein the wall has an arcuate shape in at least two orthogonal directions.

11. The feeding dish of claim 1 wherein each of the feeding zones has a substantially continually increasing cross sectional area as the feeding zone approaches the upper peripheral edge portion.

12. The feeding dish of claim 1, further comprising a restrictor member removably attached to and projecting radially from the protrusion toward the peripheral edge portion and over portions of the feeding zones immediately adjacent to the protrusion.

13. A feeding dish for use in feeding an animal, comprising:
a bowl having a curvilinear interior surface that defines a concave interior area; and
a protrusion connected to the bowl and projecting into the interior area, the protrusion having a central portion and at least three integrally connected lobes projecting radially from the central portion, the integrally connected lobes in combination with the bowl and the protrusion define at least three curvilinear feeding zones in the interior area configured to contain food and sized to prevent an animal from taking a full bite of food.

14. The feeding dish of claim 13 wherein the protrusion is integrally connected to the bowl.

15. The feeding dish of claim 13 wherein the protrusion has three lobes symmetrically disposed within the interior area.

16. The feeding dish of claim 13 wherein the integrally connected lobes are integrally connected to the protrusion.

17. The feeding dish of claim 13 wherein the at least one of the lobes include a bulbous distal.

18. The feeding dish of claim 13 wherein at least one of the lobes project from the bottom surface into the interior area at a height less than the upper peripheral edge portion.

19. The feeding dish of claim 13, further comprising a restrictor member removably attached to and projecting radially from the protrusion toward a peripheral edge portion of the bowl and over portions of the feeding zones immediately adjacent to the protrusion.
